(19) United States
(12) Patent Application Publication
(10) Pub. No.: US 2022/0352529 A1
(43) Pub. Date: Nov. 3, 2022

(54) FUEL CELL PLATE, BIPOLAR PLATE AND FUEL CELL DEVICE

(71) Applicants: AUDI AG, Ingolstadt (DE); Volkswagen AG, Wolfsburg (DE)

(72) Inventors: Christian LUCAS, Braunschweig (DE); Rune STAECK, Gifhorn (DE)

(21) Appl. No.: 17/621,109

(22) PCT Filed: Jun. 10, 2020
(86) PCT No.: PCT/EP2020/066012

§ 371 Date: Dec. 20, 2021

(30) Foreign Application Priority Data
Jul. 3, 2019 (DE) 10 2019 209 766.9

(51) Int. Cl. H01M 8/0226; H01M 8/0258; H01M 8/0267; H01M 8/0213; H01M 8/0215; H01M 8/0228; H01M 8/0206; H01M 8/1004

(52) U.S. Cl. CPC H01M 8/0226; H01M 8/0258; H01M 8/0267; H01M 8/0213; H01M 8/0215; H01M 8/0228; H01M 8/0206; H01M 8/1004

(57) ABSTRACT

A fuel cell plate for distributing a reactant at an electrode or a gas diffusion layer of a fuel cell has a plate body in which at least one flow field is incorporated, comprising at least one duct. The plate body has hygroscopic and electrically conductive properties.

### BACKGROUND

### Technical Field

Embodiments of the invention relate to a fuel cell plate for distributing a reactant at an electrode or a gas diffusion layer of a fuel cell, having a plate body in which at least one flow field is incorporated, comprising at least one duct. Embodiments of the invention furthermore relate to a bipolar plate comprising at least one such fuel cell plate, as well as a fuel cell device having such a bipolar plate.

### Description of the Related Art

For an efficient fuel cell reaction, the membrane of the membrane electrode assembly must be kept moist enough to encourage the proton transport. On the other hand, water is also formed during the fuel reaction, and this has to be removed from the fuel cell. At low fuel cell power, water can therefore build up in the fine flow ducts in the flow field of the fuel cell plate, and it cannot always be forced out from them, due to the low flow velocities of the reaction gases. When the fuel cell is shut off, the water may freeze at low outdoor temperatures. Condensing or freezing water is not only a problem for the uniform supply of process gas to the fuel cell, but also it encourages corrosion of the fuel cell plates or also the bipolar plates containing them. A known concept for dealing with this problem calls for applying hydrophilic coatings on the fuel cell plate, thereby greatly reducing the contact angle of water on the coating, so that the result is a flattening and broad distributing of water droplets and the formation of a thin water film in the ducts, no longer clogging them for the process gases. In US 2011/0014548 A1, for example, a method is described in which a carbon-based bipolar plate is functionalized by a covalent bonding to a hydrophilic group. In US 2009/0214927 A1, a bipolar plate is provided with a coating by means of an atomic layer deposition, resulting in a contact angle of water on the coating which is less than 40 degrees, imparting hydrophilic properties to the bipolar plate. Also in US 2007/0298309 A1 a coating is applied to a bipolar plate, imparting hydrophilic properties to it. In all three cited publications, the coating is furthermore configured to conduct electrons, i.e., to be electrically conductive. In DE 10 2008 034 545 A1, a different concept is proposed to prevent the blocking of the ducts, wherein the ducts are provided with a cross-linked three-dimensional structure having an appropriate porosity in itself and possessing hydrophilic properties.

Modes of operation of the fuel cell device or the fuel cell may occur during which liquid water is not produced in sufficient amount, so that the fuel cell becomes too dry. This may lead to power and service life limitations.

### BRIEF SUMMARY

Some embodiments provide a fuel cell plate, a bipolar plate and a fuel cell device to assure a more uniform or homogeneous moistening inside the fuel cell.

The fuel cell plate is characterized in particular in that the plate body has both hygroscopic and electrically conductive properties.

In this context, accordingly, there is not only present a coating having hydrophilic properties, but also the plate body of the fuel cell plate is formed hygroscopic as such, and can thus take up water, store it temporarily, and return it homogeneously to dry process gases. Also, oftentimes, there is only sufficient water present at the exit of a fuel cell stack, which can then be sucked up through the material of the plate body and also be transported to areas on the stack entrance side, if suitable transport forces are present. Furthermore, the plate body may have a capillary activity, for example so that it can transport water uniformly from a water tank, especially to take it from a wet exit of the fuel cell plate or a bipolar plate to its dry entrance.

In this context, the plate body may consist of a composite material, comprising at least one hygroscopic material and at least one electrically conductive material. This offers the benefit of having a sufficiently good electrical connection of the fuel cell plates or bipolar plates, which is usually necessary when the fuel cells are arranged in a fuel cell stack.

This opens up the possibility of the plate body consisting of a compound, i.e., a composite material having a plastic component. This compound may be present in foamed or sintered form, and furthermore it contains industrial-grade carbon black, in order to impart to the plate body an electrical conductivity, besides its hygroscopic property. Suitable plastics might be, for example, polyethylene or polypropylene, to which carbon black has been added. Such a foamed or sintered compound containing industrial-grade carbon black furthermore offers the benefit of a very low weight.

However, a plate body can also be imparted hygroscopic and electrically conductive properties in that the plate body consists of a hygroscopic and electrically conductive material which is formed from a porous metal foam or a sintered metal. One may consider here, for example, the use of stainless steel. This comes with the benefit that the fuel cell plate has very good strength and therefore stability, thanks to the metal foam used or the sintered metal used, which is especially advantageous if the fuel cell plate is press-fitted with a large clamping force in a fuel cell stack.

One material which has proven to have especially easy shaping ability and hygroscopic properties is calcium silicate. In order to impart electrical conductivity in addition to this material, graphite is mixed in additionally during the pressing or the shaping of the plate body. Hence, the result is a plate body made from a composite material which comprises at least one hygroscopic material and at least one electrically conductive material.

Due to the plate body of the bipolar plate having hygroscopic and electrically conductive properties, it is not possible—at least initially—to employ this fuel cell plate in a bipolar plate with a coolant flow, since the coolant might get through the material of the plate body and reach the membrane electrode assembly of the fuel cell. But there is the possibility of using deionized water for the cooling of the fuel cell, which furthermore promotes an active moistening of the membrane and at the same time prevents damage due to the active voltages.

But in order to also use non-deionized water for the cooling of the fuel cell, the flow field may be provided, at least for a portion, especially ductwise, with an electrically conductive coating impervious to coolants. In particular, at least one or more of the ducts of the flow field will have a water barrier thanks to this coating.

Alternatively or additionally to the coating, however, the flow field can also be associated with an electrically conductive separating element, impervious to coolant, for example in the form of a separating plate, which is designed to retain in the flow field a coolant flowing in the flow field. Such a separating element can be formed for example from graphite or a metal and be subjected to various shaping processes, depending on the desired flow cross section of the ducts of the flow field. Furthermore, the possibility exists, when using a fuel cell plate in a bipolar plate, of using this separating element to allow a first coolant, such as water, to flow in a first partial region of the bipolar plate and to allow a second coolant, but now deionized water, to flow in a second region of the fuel cell plate. Thanks to this partitioning of the coolant flows, it is also possible to use, for example, a smaller deionization filter in the cooling circuit, which reduces the complexity of the fuel cell device, for example when it is used in a fuel cell vehicle.

The bipolar plate described herein comprises a fuel cell plate as described herein and comprises a first flow field for distributing a first reactant on a first side of the bipolar plate, a second flow field for distributing a second reactant on a second side of the bipolar plate, and a coolant flow field formed between the fuel cell plate and an additional unipolar plate.

The configurations discussed for the fuel cell plate hold equally for the bipolar plate comprising such a fuel cell plate. The bipolar plate has the advantage that, thanks to the plate body made of hygroscopic and electrically conductive material, it can itself take up water (droplets) at the end of the fuel cell and thus prevent a flooding of the fuel cell or individual ducts. Thanks to the hygroscopic material component, the water can then be stored inside the bipolar plate and be distributed uniformly, for example along the ducts. The stored liquid could then be given up to a dry gas flow, for example, when the fuel cell device is being operated at a corresponding load point.

An especially simple construction can be achieved in that the unipolar plate itself is formed from a metal or from graphite, so that this need not have the hygroscopic properties of the fuel cell plate. It has been found that such a hybrid construction, namely, having a fuel cell plate with a plate body made of hygroscopic and electrically conductive properties and a unipolar plate without the hygroscopic properties, may be adequate.

However, in order to achieve an even more uniform distribution of the liquid over the bipolar plate, it has proven to be advisable for the unipolar plate to also be formed like a fuel cell plate, the plate body of which has hygroscopic and electrically conductive properties.

The fuel cell device comprises a membrane electrode assembly having two bipolar plates clamping the membrane electrode assembly between them, as was explained above. The embodiments described for the fuel cell plate and bipolar plate hold as well for the fuel cell device described herein.

The features and combinations of features mentioned above in the specification as well as the features and combinations of features mentioned below in the description of the figures and/or shown alone in the figures can be used not only in the respective indicated combination, but also in other combinations or standing alone. Hence, embodiments which are not explicitly shown in the figures or discussed, yet emerge from the discussed embodiments and can be produced by separate combinations of features, are to be seen as also being encompassed and disclosed by the present disclosure.

### BRIEF DESCRIPTION OF THE SEVERAL VIEWS OF THE DRAWINGS

Further advantages, features and details will emerge from the claims, the following description, and the drawings.

FIG. 1 illustrates a schematic cross sectional view through a fuel cell device having two bipolar plates, whose individual half-plates are each formed with a plate body made of hygroscopic and electrically conductive material.

FIG. 2 illustrates a representation corresponding to FIG. 1 with separating element.

FIG. 3 illustrates a representation corresponding to FIG. 2 with a different configuration of the separating element.

FIG. 4 illustrates a representation corresponding to FIG. 2 with different fuel cell plates and unipolar plates.

FIG. 5 illustrates a further embodiment corresponding to the representation of FIG. 1.

FIG. 6 illustrates a further embodiment of a fuel cell device.

FIG. 7 illustrates a fuel cell stack made of multiple bipolar plates and membrane electrode assemblies.

### DETAILED DESCRIPTION

Fuel cells use the chemical reaction of a fuel with oxygen to form water in order to generate electrical energy. For this, fuel cells contain as their key component the so-called membrane electrode assembly (MEA), which is a structure made from an ion-conducting, especially proton-conducting membrane and a catalytic electrode (anode and cathode) arranged on either side of the membrane. In the operation of the fuel cell, the fuel, especially hydrogen H₂ or a hydrogen-containing gas mixture, is supplied to the anode, where an electrochemical oxidation occurs, giving off electrons (H₂→2H⁺+2e⁻). Through the membrane, which separates the reaction spaces in gas-tight manner from each other and electrically isolates them, a (water-bound or water-free) transport of the protons H⁺ occurs from the anode space to the cathode space. The electrons e⁻furnished at the anode are carried along an electrical conduit to the cathode. The cathode is supplied with oxygen or an oxygen-containing gas mixture, so that a reduction of the oxygen occurs, taking up the electrons (½ O₂+2e⁻→O⁻²). At the same time, the oxygen anions in the cathode space react with the protons transported across the membrane to form water (2H⁺+O²⁻→H₂O).

As a rule, the fuel cell is formed by a plurality of membrane electrode assemblies 2 arranged in a stack, the electrical powers of which are added up. Each time a bipolar plate 3 is arranged between two of the membrane electrode assemblies 2 in a fuel cell stack, serving on the one hand for the supplying of the process gases to the anode or cathode of the neighboring membrane electrode assembly and for taking away heat. Bipolar plates 3 furthermore consist of an electrically conductive material, in order to produce the electrical connection. Hence, they have a threefold function of process gas supply to the membrane electrode units, cooling, as well as the electrical connection. For manufacturing reasons, the bipolar plates 3 are usually made from two single plates which are pressed and possibly connected together, usually being joined or glued together.

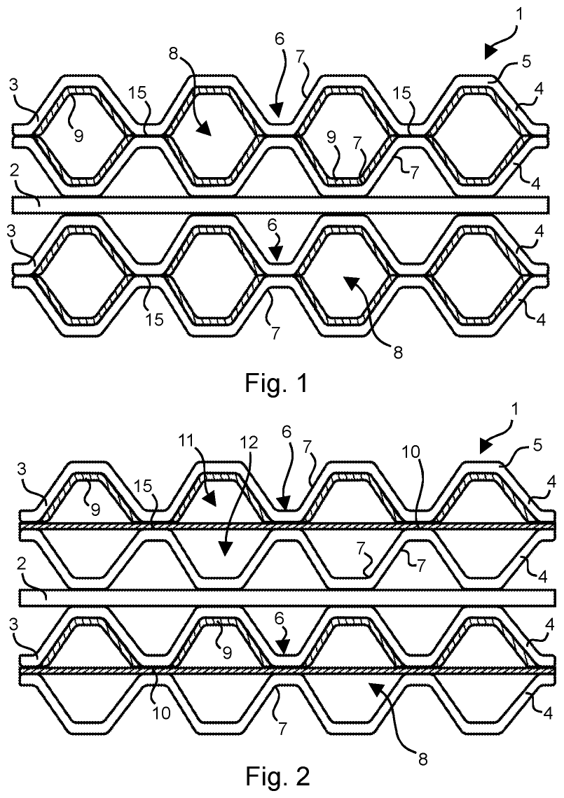

FIG. 1 shows a schematic cross sectional view through a fuel cell device 1, where the membrane electrode assembly 2 here is clamped between two individual bipolar plates 3. The bipolar plates 3 each comprise at least one fuel cell plate 4 for distributing a reactant on one of the electrodes of the membrane electrode assembly 2. In its plate body 5 there is incorporated a flow field 6, having at least one duct 7 or a plurality of ducts 7. The plate body 5 itself has hygroscopic and electrically conductive properties. In the present instance, it consists of a composite material, comprising at least one hygroscopic material and at least one electrically conductive material. As the hygroscopic material, calcium silicate has proven to be advantageous, graphite being mixed in with it in order to assure an electrical conductivity. Hence, the plate body 5 is thus hygroscopic and electrically conductive, and may also be capillary-active, in order to suck up liquid water. It distributes the liquid water homogeneously and uniformly on the plate body 5, so that it can also be given off homogeneously and uniformly to a dry process gas flow, in order to prevent a flooding of the fuel cells on the one hand, and to bring about a more uniform moistening of the membrane of the membrane electrode assembly 2 on the other hand. Thanks to the hygroscopic and electrically conductive properties of the plate body 5 of the individual fuel cell plates 4, it is basically possible for a coolant flow field 8 formed between two of the fuel cell plates 4 to take coolant to the membrane electrode assembly 2. In order to prevent this, in the configuration of FIG. 1 the flow field 6 is provided entirely with an electrically conductive coating 9, yet one which is impervious to coolant. For this, the coating 9 may consist of graphite or contain graphite. Furthermore, a metallic coating 9 might be considered. The coating 9 ensures that no charges reach the electrodes of the fuel cell through the coolant, such as might cause unwanted voltage changes there. The bipolar plates 3 shown in FIG. 1 are assembled from two individual fuel cell plates 4, the webs of which are aligned with each other in order to form coolant ducts between them. A further flow field 6 on the side of the two fuel cell plates 4 facing away from the coolant ducts then serves for the supplying and distributing of reactant on the electrodes of the respective neighboring membrane electrode assembly 2. The individual fuel cell plates 4 of the particular bipolar plate 3 are electrically coupled to each other by suitable contacts 15.

FIG. 2 shows additional bipolar plates 3, likewise being formed from two of the fuel cell plates 4 having a plate body 5 made of hygroscopic and electrically conductive material. But in this instance only one of the two individual fuel cell plates 4 is provided with an electrically conductive, yet coolant-impervious coating 9. The second fuel cell plate 4 of the bipolar plate 3, on the other hand, is free of coating. Thanks to the plate body 5 having hygroscopic and electrically conductive properties of the coating-free fuel cell plate, it is ensured that no ions reach the membrane electrode assembly 2. This means that the coolant ducts in the present instance are partitioned or separated by a separating element 10 impervious to coolant, which is designed to retain coolant flowing in the coolant flow field 8 of the fuel cell plate 4 provided with a coating 9 in this flow field. In the present instance, the separating element 10 is formed as a separating plate, comprising graphite or metal or consisting of such. In the other part of the coolant duct, however, a coolant can still flow, for example a coolant in the form of deionized water, in order to bring about a corresponding cooling. However, it should be noted that two different coolant circuits are present, namely, a first cooling circuit 11 for normal, not necessarily deionized coolant and a second cooling circuit 12 for a deionized coolant. However, the two circuits can also be connected to each other, in which case appropriate deionization filters or deionization devices with appropriate membranes for filtering the ions will be used.

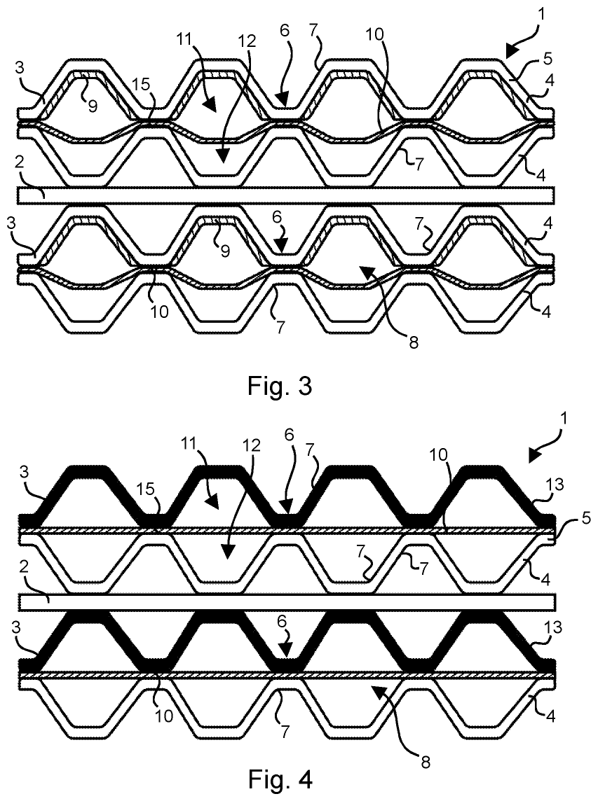

One notices from FIG. 3 that the separating element 10 may also be shaped in various ways, so that the flow cross sections for a deionized coolant and those for a non-deionized coolant can be adapted by the shaping of the separating element 10.

FIG. 4 shows a further embodiment of a fuel cell device 1, comprising on the one hand a fuel cell plate 4 having a plate body made of hygroscopic and electrically conductive material and a second unipolar plate 13 made from a plate body having only electrically conductive properties, but no hygroscopic properties. This unipolar plate 13 is formed for example from a metal or from graphite, or it comprises at least one of these. Here as well there is present a separating element 12, in order to divide the coolant flow into a first portion in which normal, non-deionized coolant flows and a second portion in which deionized coolant is used.

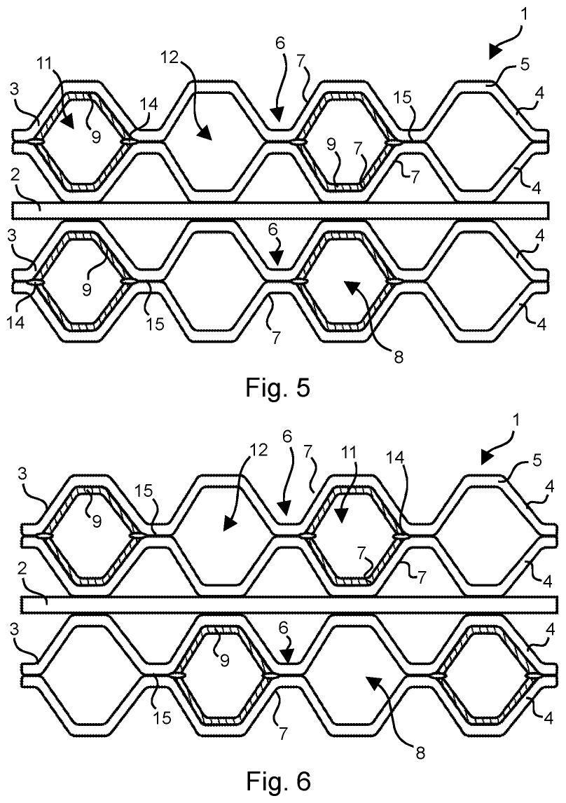

FIG. 5 shows another fuel cell device 1, once again comprising a bipolar plate 3, formed from two fuel cell plates 4 having a plate body 5 made of hygroscopic and electrically conductive material. However, only individual ducts here are provided with a coating 9 made from an electrically conductive, yet coolant-impervious material. Thus, a coolant not necessarily being also deionized can flow in these flow ducts. In the other, uncoated flow ducts there can be once again a flow of a deionized coolant, such as deionized water, in order to bring about a cooling and an additional moistening of the membrane. For additional security that no non-deionized coolant makes contact with the material of the hygroscopic and electrically conductive plate body 5, the tightness can be additionally assured by appropriate sealing elements 14, such as an adhesive, which is provided on the duct side of the connection site of the two half-plates of the bipolar plates 3. In the embodiment shown, the coolant flow field is configured such that the flow ducts with coating 9 are arranged alternating with the flow ducts not having a coating. Furthermore, the ducts 7 with coating and the ducts 7 without coating are respectively aligned with the bipolar plate 3 situated on the other side of the membrane electrode assembly 2.

FIG. 6 shows another configuration in which the coated flow ducts of the upper bipolar plate 3 are aligned with uncoated flow ducts of the lower bipolar plate 3 and vice versa. Here as well, one can see an alternating arrangement of the coated flow ducts and the noncoated flow ducts.

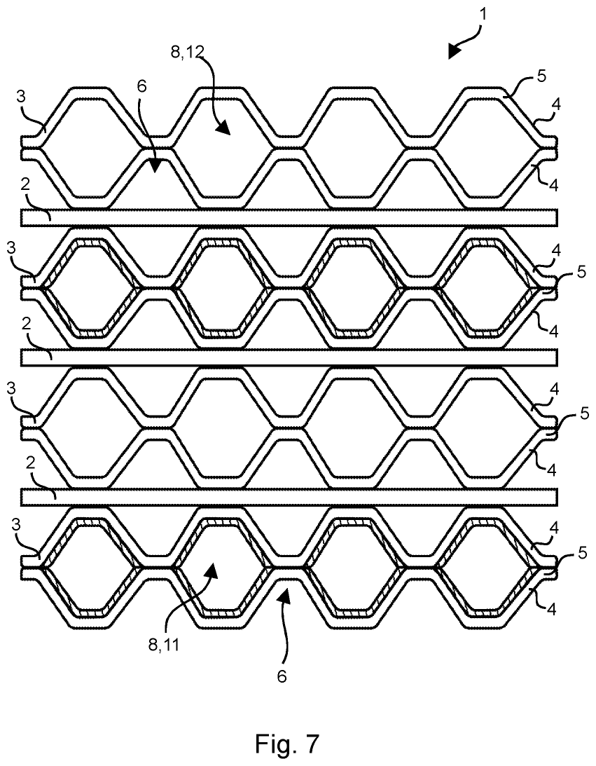

Finally, FIG. 7 shows a fuel cell device 1 having a plurality of membrane electrode assemblies 2, these membrane electrode assemblies 2 comprising on their first side a bipolar plate 3 with the uncoated flow fields 6 and on their second side a bipolar plate 3 with coated flow fields 6. The coating 9 is designed such as to seal off the flow ducts of the coolant conduits.

As a result, the embodiments described herein are distinguished by an improved water management for a fuel cell device 1 thanks to the use of a plate body 5 having hygroscopic and electrically conductive properties.

Aspects of the various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled.

1. A fuel cell plate for distributing a reactant at an electrode or a gas diffusion layer of a fuel cell, comprising:
a plate body forming at least one flow field and including at least one duct;
wherein the plate body is formed from a mixture of calcium silicate and graphite and is hygroscopic and electrically conductive.

2. The fuel cell plate according to claim 1, wherein the plate body comprises a composite material, including at least one hygroscopic material and at least one electrically conductive material.

3-4. (canceled)

5. The fuel cell plate according to claim 1, wherein at least a portion of the flow field is provided with an electrically conductive coating that is impervious to coolants.

6. The fuel cell plate according to claim 1, wherein the flow field is associated with an electrically conductive separating element that is impervious to coolant and that is designed to retain a coolant flowing in the flow field.

7. A bipolar plate, comprising:
a first unipolar fuel cell plate for distributing a reactant at an electrode or a gas diffusion layer of a fuel cell, the first unipolar fuel cell plate having a plate body including at least one duct, wherein the plate body is formed from a mixture of calcium silicate and graphite and is hygroscopic and electrically conductive;
a first flow field for distributing a first reactant on a first side of the bipolar plate;
a second flow field for distributing a second reactant on a second side of the bipolar plate; and
a coolant flow field formed between the first unipolar fuel cell plate and a second unipolar fuel cell plate.

8. The bipolar plate according to claim 7, wherein the second unipolar fuel cell plate is formed from a metal or from graphite.

9. The bipolar plate according to claim 7, wherein the second unipolar fuel cell plate is formed for distributing a reactant at an electrode or a gas diffusion layer of a fuel cell, the second unipolar fuel cell plate including a plate body forming at least one flow field and including at least one duct, wherein the plate body is formed from a mixture of calcium silicate and graphite and is hygroscopic and electrically conductive.

10. A fuel cell device, comprising:
a membrane electrode assembly;
a first bipolar plate for distributing a reactant, the first bipolar plate having a first plate body that is formed from a mixture of calcium silicate and graphite and is hygroscopic and electrically conductive;
a second bipolar plate for distributing a reactant, the second bipolar plate having a second plate body that is formed from a mixture of calcium silicate and graphite and is hygroscopic and electrically conductive;
wherein the membrane electrode assembly is clamped between the first bipolar plate and the second bipolar plate.
